(19) United States
(12) Patent Application Publication
(10) Pub. No.: US 2019/0039483 A1
(43) Pub. Date: Feb. 7, 2019

(54) HEIGHT ADJUSTMENT DEVICE FOR THE HEIGHT ADJUSTMENT OF A SEAT FRAME OF A VEHICLE SEAT AND VEHICLE SEAT HAVING THE HEIGHT ADJUSTMENT DEVICE

(71) Applicant: GM GLOBAL TECHNOLOGY OPERATIONS LLC, Detroit, MI (US)

(72) Inventors: Andreas Meinel, Mainz-Kastel (DE); Juergen Maier, Weitersweiler (DE); Thomas Christoffel, Kaiserslautern (DE)

(73) Assignee: GM GLOBAL TECHNOLOGY OPERATIONS LLC, Detroit, MI (US)

(21) Appl. No.: 16/048,794

(22) Filed: Jul. 30, 2018

(30) Foreign Application Priority Data
Aug. 1, 2017 (DE) 102017007263.9

(51) Int. Cl. B60N 2/16

(52) U.S. Cl. CPC B60N 2/165; B60N 2/1615

(57) ABSTRACT

A height adjustment device is disclosed for the height adjustment of a seat frame for a vehicle seat. The height adjustment device includes a rotatable gear shaft and a gear wheel having a plurality of gear wheel teeth. A sector spur gear is arranged coaxially with the gear shaft and includes a recess receiving the gear wheel such that the sector spur gear is in operative connection with the plurality of gear wheel teeth.

### CROSS-REFERENCE TO RELATED APPLICATION

This application claims priority to German Patent Application No. 10 2017 007 263.9, filed Aug. 1, 2017, which is incorporated herein by reference in its entirety.

### TECHNICAL FIELD

The present disclosure relates to a height adjustment device for a seat frame of a vehicle seat and a vehicle seat having the height adjustment device.

### BACKGROUND

Many vehicle seats are adjustable in height and for this purpose often have a spur gear operatively connected to a shaft and a gear wheel. The spur gear and the gear wheel mesh with each other, so that the vehicle seat is adjusted in height via a lever action generated by the meshing. For example, US 2001/0022460, which is the US counterpart of DE 10059149 C2, describes a height adjustment device for a vehicle seat having a sector spur gear which has external teeth, and having a pinion that meshes with the external teeth of the sector spur gear.

Such conventional height adjustment devices have external teeth, and it is necessary during assembly to provide clearance compensation between the gear wheel and the sector spur gear at the respective seat frame section in order to achieve an effective tooth overlap between the teeth of the sector spur gear and the gear wheel teeth. The clearance compensation is often done by shifting the gear wheel along the seat frame section in slot holes provided for this purpose. For this purpose, the gear wheel must be subjected to a force during assembly that pushes and/or shifts the gear wheel in the direction of the sector spur gear.

FIGS. 1 and 2 show a vehicle seat having a height adjustment device 1a known from the general prior art for the vehicle seat. The seat frame is mounted via at least one mounting device 16a of the vehicle seat movable in at least one guide rail 22a of the vehicle seat fastened on a vehicle floor. For example, the mounting device 16a is configured as a carriage movable on the guide rail 22a. The height adjustment device 1a is configured to transfer the seat frame and thus the vehicle seat from a lowermost position to at least one raised position.

The height adjustment device 1a has a sector spur gear 3a and an adjusting and/or locking device 4a (FIG. 2) with a non-visible gear wheel. The adjusting and/or locking device 4a is arranged on the outside of the seat frame section 2a and is fastened to the seat frame section 2a in a fixed and non-rotatably manner via a fixing plate 6a (FIG. 1) arranged on the inside. For this purpose, threaded bolts 11a of the adjusting and/or locking device 4a are guided through slot holes 10a (FIG. 2), which are introduced into the seat frame section 2a.

The adjusting and/or locking device 4a includes the gear wheel, which has gear wheel teeth for meshing with external teeth 8a of the sector spur gear 3a. The adjusting and/or locking device 4a may optionally include a locking element which locks a meshing position of the external teeth 8a and the gear wheel teeth and thereby fixes the seat frame or the vehicle seat at a certain height.

The fixing plate 6a includes nuts 12a which are screwed onto the threaded bolts 11a in order to fasten the adjusting and/or locking device 4a to the seat frame section 2a.

The sector spur gear 3a has the external teeth 8a with numerous teeth. The sector spur gear 3a is mounted non-rotatably together with a lever device 15a of the height adjustment device 1a on a rotatable gear shaft 14a. The gear shaft 14a has a handling device, not shown, or is connected thereto, with which an occupant sitting on the vehicle seat can set the gear shaft 14a into rotation in order to adjust the seat frame and thus the vehicle seat in height. The lever device 15a connects the lever device 15a to the gear shaft 14a. For this purpose, the lever device 15a is pivotally connected to the mounting device 16a at a pivot point 17a.

Upon rotation of the gear shaft 14a, the external teeth 8a of the sector spur gear 3a mesh with the gear wheel teeth of the gear wheel. With and/or by the meshing, the lever device 15a is pivoted relative to the mounting device 16a from a low position T to at least a high position H and back, so that the gear shaft 14a and the seat frame section 2a are raised or lowered by the lever device 15a relative to the mounting device 16a.

In order to achieve a proper functional meshing and/or engagement of the teeth 7a of the external teeth 8a with/in the gear wheel teeth of the gear wheel, it is necessary to act upon the adjusting and/or locking device 4a with a force F during assembly of the adjusting and/or locking device 4a (FIG. 2) on the seat frame section 2a, which force is directed against the sector spur gear 3a.

The application of the force F pushes the gear wheel 5a against the sector spur gear 3a and/or adjusts with respect to the sector spur gear 3a so that sufficient tooth overlap between the teeth 7a of the sector spur gear 3a and the gear wheel teeth 9a of the gear wheel 5a is ensured. The slot holes 10a are provided in the seat frame section 2a for pushing the adjusting and/or locking device 4a against the sector spur gear 3a and/or for adjusting the same. During assembly, the threaded bolts 11a of the adjusting and/or locking device 4a are inserted through the slot holes 10a, the adjustment and/or locking device 4a is shifted along the slots 10a and/or is adjusted by applying the force F relative to the sector spur gear 3a.

The necessity of the shifting and adjustment of the adjustment and/or locking device 4a in the slot holes 10a increases a time expenditure and cost of assembling the height adjustment device 1a on the seat frame section 2a.

### SUMMARY

In accordance with the present disclosure, a functionally improved height adjustment device for a vehicle seat is described. Preferred or advantageous embodiments of the height adjustment device will become apparent from the dependent claims of the following description and/or the accompanying figures. The height adjustment device is configured for height adjustment of a vehicle seat, in particular for a car, truck, bus, or similar vehicles. Likewise, the vehicle seat is configured, for example, as a driver's seat, passenger's seat, or as a seat of a rear seat row of the vehicle. Preferably, the vehicle seat is arranged on a floor of the vehicle and mounted in a mounting device, for example, first and second mounting devices. The mounting devices are configured as carriages, on which the vehicle seat can be moved relative to the vehicle floor, for example, along two guide rails in a longitudinal direction generally counter to a direction of travel of the vehicle.

Preferably, the vehicle seat includes a seat frame, which is arranged below a seat cushion of the vehicle seat. The seat frame may include first and second seat frame sections, which are arranged parallel to and spaced from each other and in particular run in the seat direction. The first seat frame section is movably mounted on the first guide rail of the vehicle via the first and optionally via a further mounting device. In particular, the second seat frame section is mounted on a second guide rail via the second mounting device and optionally via an additional mounting device.

An occupant may sit on the seat cushion in a seat direction and in particular lean against a backrest of the vehicle seat. In particular, the seat cushion is mounted on the seat frame and/or carried thereby. The seat frame may be transferred by the height adjustment device from a lowermost position into at least one raised position and transferred back, so that it is adjustable in height with respect to the vehicle floor. In particular, the vehicle seat is adjustable in height via the seat frame and thereby adaptable to different body sizes of the occupant.

The height adjustment device has a rotatable gear shaft. The gear shaft extends below the seat cushion of the vehicle seat transversely to the seat direction, preferably between the two seat frame sections of the seat frame and/or connects both seat frame sections to each other. The gear shaft is rotatably mounted in the two seat frame sections.

It is preferred that the gear shaft is connected to an actuating device. Alternatively or additionally, the gear shaft includes the actuating device such that the occupant can rotate the gear shaft by using the actuator. It is preferred that the gear shaft, in particular due to the mounting in the seat frame sections, is adjustable in height together with the seat frame.

The height adjustment device includes a sector spur gear. The sector spur gear is arranged coaxially with the gear shaft. Furthermore, the height adjustment device has a gear wheel. The gear wheel includes a plurality of gear wheel teeth. The sector spur gear is in operative connection with the gear wheel. The sector spur gear has a recess for the gear wheel. The gear wheel is arranged in the recess.

In a preferred embodiment of the present disclosure, the sector spur gear has internal teeth. Preferably, the internal teeth are arranged on an edge section of the recess. In particular, the internal teeth are configured for meshing with the gear wheel teeth of the gear wheel arranged in the recess. In particular, the height adjustment of the seat frame takes place with and/or by the meshing of the internal teeth with the gear wheel teeth. The internal teeth extend coaxially with the gear shaft. Preferably, the internal teeth include a plurality of teeth. In particular, each of the teeth has a tip. It is particularly preferred that the tips of the teeth are aligned with the gear shaft and/or point to the gear shaft.

The present disclosure provides that the sector spur gear is mounted non-rotatably on the gear shaft. The sector spur gear is thereby rotatable together with the gear shaft, in particular when the occupant actuates the actuating device. Preferably, the sector spur gear extends out from the gear shaft in the same direction to at least one of the two seat frame sections. In particular, the recess of the sector spur gear is thereby arranged adjacent to the respective seat frame section. Specifically, the sector spur gear is pivotable over at the seat frame section when the gear shaft rotates.

In the present disclosure, the gear wheel is arranged fixed, immovable and/or non-rotatable to the seat frame, in particular on the at least one of the two seat frame sections. For example, the gear wheel is arranged on the corresponding seat frame section so as to be arranged in the recess of the adjacent sector spur gear. In particular, the gear wheel teeth can thereby mesh with the internal teeth of the sector spur gear. Specifically, the sector spur gear rotates together with the gear shaft and/or is pivoted over at the seat frame section so that the internal teeth mesh with the gear wheel teeth of the gear wheel.

Due to the arrangement of the gear wheel in the recess, the proposed height adjustment device does not require such clearance compensation during assembly since the necessary tooth overlap between the gear wheel teeth and the internal teeth of the sector spur gear arranged on the edge section of the recess is already given. In particular, the gear wheel is pressed by the resulting forces in the internal teeth of the sector spur gear during height adjustment. As a result, the tolerance compensation via the slot holes in the respective seat frame section can be dispensed with in an advantageous manner. In particular, assembly time and costs can be saved. Furthermore, a pulling out of the gear wheel teeth and the internal teeth can be avoided in a vehicle collision, so that an undesirable sliding of the seat frame and/or the vehicle seat can be avoided in an advantageous manner.

Another advantage that results from dispensing with the tolerance compensation during assembly of the gear wheel, is that in case of a defect of the height adjustment device, this or only some of the components of the height adjustment device can be easily and quickly replaced. An exchange of the entire seat frame having the height adjustment device, as is necessary in conventional height adjustment devices, can be dispensed with.

It is particularly preferred that the height adjustment device includes a lift lever. Preferably, the lift lever is configured for raising and/or lowering the seat frame relative to the first and second mounting device of the vehicle seat. The seat frame and/or the vehicle seat can thereby be transferred from the lowermost position into at least one raised position and vice versa. For this purpose, the lift lever can be transferred preferably from a low position, in which the seat frame takes the lowermost position into at least one high position, in which the seat frame and/or the vehicle seat takes the at least one raised position.

In a preferred embodiment of the present disclosure, the lift lever is operably coupled with the gear shaft. Preferably, the lift lever is mounted non-rotatably with a first lever section on the gear shaft. In particular, the lift lever having the first lever section is mounted non-rotatably together with the sector spur gear on the gear shaft. It is particularly preferred that the lift lever is pivotally mounted with a second lever section in at least one of the two mounting devices. In particular, the lift lever pivotably connects the at least one mounting device to the gear shaft. The non-rotatable coupling of the lift lever with the gear shaft particularly ensures that the lift lever can be transferred from the low position into the at least one high position and back again with the meshing of the internal teeth with the gear wheel teeth. In particular, the gear shaft can thereby be raised and lowered together with the seat frame.

In another aspect, the present disclosure forms a vehicle seat having the seat frame and the height adjustment device according to the previous description. Additionally, the vehicle seat includes the first and second mounting device and/or the two guide rails.

In addition, other objects, desirable features and characteristics will become apparent from the subsequent summary and detailed description, and the appended claims, taken in conjunction with the accompanying drawings and this background.

### BRIEF DESCRIPTION OF THE DRAWINGS

The present disclosure will hereinafter be described in conjunction with the following drawing figures, wherein like numerals denote like elements.

FIGS. 1 and 2 illustrate a conventional height adjustment device for a vehicle seat;

FIG. 3 illustrates a seat frame of a vehicle seat having a height adjustment device shown in FIGS. 4 and 5;

FIG. 4 is a perspective view of the height adjustment device for the seat frame shown in Fig. F3; and

FIG. 5 is a side elevation showing the height adjustment device with a gear shaft, a sector spur gear, a gear wheel and a lift lever.

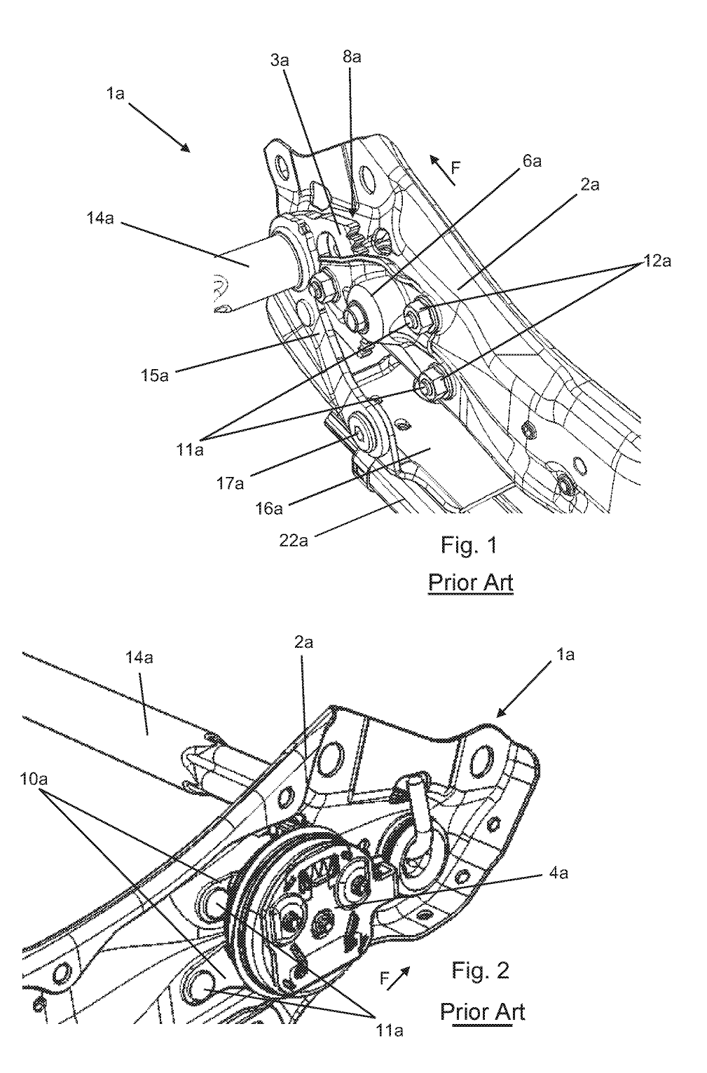

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

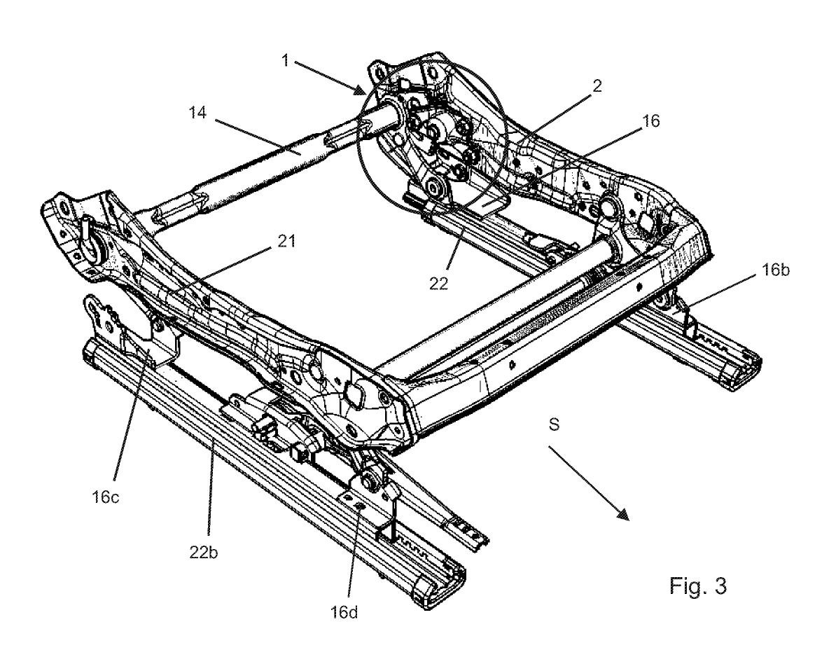

Relative to conventional mechanisms, a functionally improved, easy and inexpensive to install height adjustment device 1 is provided for the vehicle seat with the embodiments of FIGS. 3-5. FIG. 3 shows a seat frame 20 which is part of a vehicle seat. The seat frame 20 is arranged below a seat cushion of the vehicle seat and/or carries this. An occupant of the vehicle can take a position on the seat cushion and looks in a sitting direction S of the vehicle seat. The vehicle seat can be integrated into a vehicle, in particular in a car, truck, bus, etc. It is configured, for example, as a driver's seat, passenger's seat or as a seat of a rear seat row of the vehicle.

The seat frame 20 includes a first seat frame section 2 and a second seat frame section 21 running parallel in the seat direction S. The first seat frame section 2 is mounted on a first and second mounting device 16, 16b and the second seat frame section 2b is mounted on a third and fourth mounting device 16c, 16d. The mounting devices 16, 16b, 16c, 16d are configured as carriages which are movable on two guide rails 22, 22b of the vehicle seat, which are parallel to one another and fastened to a vehicle floor, in and counter to the seat direction S.

The vehicle seat has the height adjustment device 1, with which the seat frame 20 and thus the vehicle seat is adjustable in height. The seat frame 20 and the vehicle seat can thereby be transferred from a lowermost position to at least one raised position and back and can be adapted to a body size of the occupant.

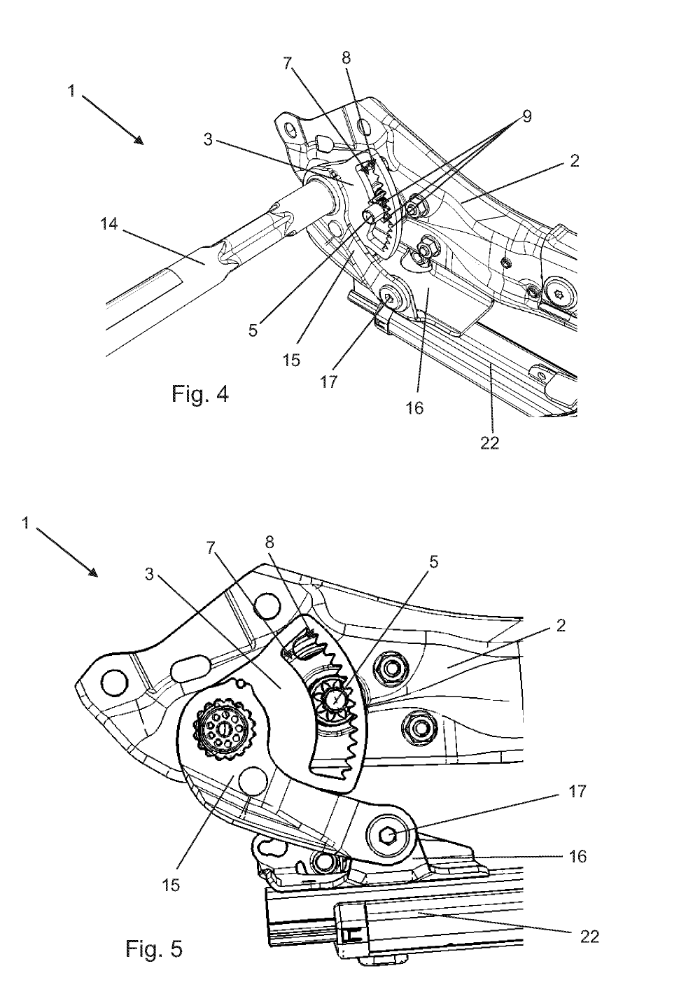

The height adjustment device 1 from FIG. 3 is shown in different views in FIGS. 4 and 5. FIG. 4 shows the height adjustment device 1 in perspective from above, FIG. 5 in a plan view from the side.

The height adjustment device 1 includes a sector spur gear 3, a gear wheel 5, a gear shaft 14 and a lift lever 15. The gear shaft 14 extends between the first and second seat frame section 2, 21 (FIG. 3) and is rotatably mounted therein. The gear shaft 14 is connected or connectable to a handling device, not shown, via which the occupant can rotate the gear shaft 14 and thereby adjust the seat frame and the vehicle seat in height.

The first seat frame section 2 is movably mounted via the first mounting device 16 in the first guide rail 22 in and counter to the seat direction S. The lift lever 15 extends between the gear shaft 14 and the first mounting device 16 and pivotally connects both to one another. For this purpose, the lift lever 15 is mounted non-rotatably on the gear shaft 14 with a first lever section. The lift lever 15 is pivotally connected at a pivot point 17 to the mounting device 16 with a second lever section.

The sector spur gear 3 is also mounted non-rotatably on the gear shaft. It sticks out from the gear shaft 15 so that a piece extends along the first seat frame section 2. The sector spur gear 3 has a recess 7. Internal teeth 8 are arranged with a plurality of teeth at an inner edge section of the recess 7. The internal teeth 8 run on the edge section coaxial with the gear shaft 14. The teeth of the internal teeth 8 have tips that are directed to the gear shaft 14 and/or point to this.

The gear wheel 5 is non-rotatably, fixed and immovably arranged in the first seat frame section 2. It is arranged there so that it is positioned in the recess 7 of the sector spur gear 3 and/or at least partially protrudes therethrough. The gear wheel 5 has a plurality of gear wheel teeth 9 which engage with teeth of the internal teeth 8 of the sector spur gear 3 and/or can mesh with the internal teeth 8. In particular, the gear wheel teeth 9 of the gear wheel 5 mesh with the internal teeth 8 with a rotation of the gear shaft 14 generated or initiated, for example, by the occupant of the vehicle seat. With the and/or by the meshing, the lift lever 15 is pivoted from a low position into one of a plurality of possible high positions H. As a result, the gear shaft 14 and the seat frame sections 2, 20 connected thereto are raised relative to the first mounting device 16. The seat frame 20 and thus the vehicle seat are thereby transferred from the lowermost position into one of several possible raised positions.

Optionally, the height adjustment device 1 may include a locking device with a locking element which can lock a meshing position of the external teeth 8 and the gear wheel teeth 9 and thus fix the seat frame 20 and the vehicle seat at the set height.

The arrangement of the gear wheel 5 in the recess 7 of the sector spur gear 3 ensures that the gear wheel teeth 9 reliably overlap with the teeth of the internal teeth 8 and are engaged. Because of the resulting forces in the height adjustment, the gear wheel teeth 9 are pressed into the internal teeth 8 of the sector spur gear 3. This can ensure that the gear wheel teeth 9 can not pull out of the internal teeth 8 even in a vehicle collision. This has the advantage that the vehicle seat does not suddenly drop undesirably in height. In addition, it is not necessary to apply the force F during the assembly of the gear wheel 5 in order to achieve the tolerance compensation via the slot holes 10a, as shown in FIG. 2. As a result, time and costs for the assembly of the height adjustment device 1 on the seat frame 20 can be saved. Furthermore, the height adjustment device 1 can be completely or partially replaced easily and quickly in the event of a defect.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-14. (canceled)

15. A height adjustment device for a seat frame of a vehicle seat comprising:
a gear shaft configured to be rotatably supported on the seat frame;
a sector plate fixed to gear shaft for rotation therewith, the sector plate having an arcuate slot formed therein with internal teeth disposed along an edge of the arcuate slot to provide an sector spur gear; and
a gear wheel configured to be fixed to the seat frame and received in the arcuate slot and having a plurality of gear teeth engagable with the internal teeth of the sector spur gear, wherein the internal teeth mesh with the plurality of gear teeth of the gear wheel to drive the sector plate for rotating the gear shaft.

16. The height adjustment device according to claim 16, wherein a center point of the arcuate slot is coaxial with a rotational axis of the gear shaft.

17. The height adjustment device according to one of claim 16, wherein the each of the internal teeth of arcuate slot comprises a tip extending towards the gear shaft.

18. The height adjustment device according to claim 16, wherein the height adjustment device further comprises a lift lever configured to position the seat frame relative to a mounting device of the vehicle seat, wherein the lever is fixed to gear shaft for rotation therewith.

19. A seat for a vehicle comprising:
a seat frame including a pair of longitudinally extending frame members arranged in a laterally spaced relationship;
a gear shaft rotatably supported between the pair of frame members;
a lift lever having a first end fixed to the gear shaft for rotation therewith and a second end configured for coupling with the vehicle;
a sector plate fixed to gear shaft for rotation therewith, the sector plate having an arcuate slot formed therein with internal teeth disposed along an edge of the arcuate slot to provide a sector spur gear; and
a gear wheel extending from the seat frame and received in the arcuate slot, the gear wheel having a plurality of gear teeth engagable with the internal teeth of the sector spur gear, wherein the internal teeth mesh with the plurality of gear teeth of the gear wheel to drive the sector plate for rotating the gear shaft.

20. The vehicle seat according to claim 19, wherein the gear wheel is non-rotatably, fixed on the seat frame.

21. The vehicle seat according to claim 19, wherein the vehicle seat comprises a guide rail and a mounting device movably mounting the vehicle seat therein, wherein the second end of the lift lever is pivotably mounted to the mounting device, wherein the seat frame is positionable relative to the mounting device via the lift lever.

22. The vehicle seat according to claim 21, wherein the lift lever is pivotable between a low position to at least one high position when the gear shaft rotates and the internal teeth mesh with the gear wheel teeth.

23. The vehicle seat according to claim 16, wherein a center point of the arcuate slot is coaxial with a rotational axis of the gear shaft.

24. The vehicle seat according to one of claim 16, wherein the each of the internal teeth of arcuate slot comprises a tip extending towards the gear shaft.
